(19) United States
(12) Patent Application Publication
(10) Pub. No.: US 2002/0122998 A1
(43) Pub. Date: Sep. 5, 2002

(54) Charge transfer layer with hydrazone, acetosol yellow and antioxidant of butylated p-cresol reacted with dicyclopentadiene

(76) Inventors: Mark Thomas Bellino, Loveland, CO (US); David Glenn Black, Longmont, CO (US); Gregory W. Haggquist, Longmont, CO (US); Ronald Harold Levin, Boulder, CO (US); Weimei Luo-Gheleta, Louisville, CO (US); Scott Thomas Mosier, Boulder, CO (US); Dat Quoc Nguyen, Platteville, CO (US); Bradford Lee Taylor, Longmont, CO (US); Franklin Dilworth Zartman, Loveland, CO (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 09/797,038

(22) Filed: Mar. 1, 2001

(51) Int. Cl. G03G 5/05

(52) U.S. Cl. 430/58.45; 430/970; 430/59.5; 430/59.6

(57) ABSTRACT

A photoconductor having a charge transport layer in illustrative embodiments of a polycarbonate binder, 30 to 60 percent by weight DEH hydrazone, 0.5 percent to 5 percent acetosol yellow, and 0.5 percent to 5 percent by weight of the butylated reaction product of p-cresol and dicyclopentadiene. The charge generation layer by type IV oxotitanium phthalocyanine in polyvinylbutyral, poly (methyl-phenyl) siloxane and polyhydroxystyrene. Light fatigue is largely eliminated while the physical and cost advantages of DEH are realized.

### RELATED APPLICATIONS

U.S. patent application Ser. No. 09/237,880; filed Jan. 27, 1999; having some common inventors with this application is directed to corresponding charge transport layers in which the antioxidant is ester containing. U.S. patent application Ser. No. 09/584,358; filed May 31, 2000; having some common inventors with this application, is directed to charge generation layer containing the antioxidant of p-cresol reacted with dicyclopentadiene of this invention. U.S. patent application Ser. No. 09/585,045; filed June 1, 2000, is directed to charge generation layers having excellent. high-speed operability when the charge transport layer is consistent with this invention.

### FIELD OF THE INVENTION

The present invention is directed to charge transport layers of photoconductors which comprise a hydrazone charge transport compound, as well as acetosol yellow (also known as SAVINYL YELLOW and Colour Index Solvent Yellow 138) and an antioxidant.

### BACKGROUND OF THE INVENTION

In electrophotography, a latent image is created on the surface of an imaging member which is a photoconducting material by first uniformly charging the surface and selectively exposing areas of the surface to light. A difference in electrostatic charge density is created between those areas on the surface which are exposed to light and those areas on the surface which are not exposed to light. The latent electrostatic image is developed into a visible image by electrostatic toners. The toners are selectively attracted to either the exposed or unexposed portions of the photoconductor surface, depending on the relative electrostatic charges on the photoconductor surface, the development electrode and the toner.

Typically, a dual layer electrophotographic photoconductor comprises a substrate such as a metal ground plane member on which a charge generation layer (CGL) and a charge transport layer (CTL) are coated. The charge transport layer contains a charge transport material which comprises a hole transport material or an electron transport material. For simplicity, the following discussions herein are directed to the use of a charge transport layer which comprises a hole transport material as the charge transport compound. One skilled in the art will appreciate that if the charge transport layer contains an electron transport material rather than a hole transport material, the charge placed on the photoconductor surface will be opposite that described herein.

When the charge transport layer containing a hole transport material is formed on the charge generation layer, a negative charge is typically placed on the photoconductor surface. Conversely, when the charge generation layer is formed on the charge transport layer, a positive charge is typically placed on the photoconductor surface. Conventionally, the charge generation layer comprises the charge generation compound or molecule alone and/or in combination with a binder. The charge transport layer typically comprises a polymeric binder containing the charge transport compound or molecule. The charge generation compounds within the charge generation layer are sensitive to image-forming radiation and photogenerate electron hole pairs therein as a result of absorbing such radiation. The charge transport layer is usually non-absorbent of the image-forming radiation and the charge transport compounds serve to transport holes to the surface of a negatively charge photoconductor.

U.S. Pat. No. 4,362,798 to Anderson et al. discloses a layered electrophotographic plate or element having a conventional charge generation layer and a charge transport layer containing p-type hydrazone and the acetosol yellow of this invention. While that photoconductor is particularly good for use in electrophotography processes, it has been found that prolonged exposure to ambient light, and particularly to cool-while fluorescent light usually found in offices, may decrease the photosensitivity of the photoconductor. This is commonly referred to in the art as room light fatigue (RLF). Exposure of such photoconductors to cool-white ambient fluorescent lighting, even for just a few minutes, results in a significant shift in the residual voltage, commonly referred to as fatigue. This shift in residual potential means that factors such as print density and background density will be different on a print made from the fatigued drum when compared to the last print made before fatiguing this drum. Hence, when a machine is opened for the slightest reason, for example to clear a paper jam, ambient fluorescent light can enter and damage the photoconductor.

Typically, room light fatigue does not occur in high speed duplicators, since experienced, well-trained operators commonly service such devices and do not expose the photoconductor to ambient light for prolonged periods. However, room light fatigue typically occurs in low speed copiers and printers since such devices are often attended by operators having little or no training.

A number of experiments have suggested that one cause of room light fatigue is the syn-anti isomerization about the hydrazone C═N double bond. The product acts as a trap and reduces mobility of the charge transport layer. The preferred hydrazone molecule, p-diethylaminobenzaldehyde-(diphenylhydrazone) (DEH), represented by the structural formula (I), has been found to experience an undesirable change in light sensitivity when exposed to conventional cool-while fluorescent room light for 15 minutes or more.

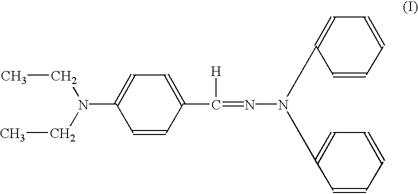

The suggestion of a syn-anti isomerization has led to various approaches in the art to prevent this isomerization. One of the first approaches was the “sunblock” approach. Just as a sunscreen retards light absorption by human skin pigments, it was suggested that incorporating a molecule that absorbs at the cool-while fluorescent wavelength would prevent this isomerization. However, large amounts of the light-absorbing molecule were typically required in order to absorb most of the damaging radiation and resulted in a marked decrease in photosensitivity as charge generation molecule (CGM) and charge transport molecule (CTM) concentrations were correspondingly reduced. Hence, this was not a viable approach to an RLF-protected, yet fully functional, photoconductor.

Additional studies in the art have involved the addition of a molecule that could quench the excited singlet state of the hydrazone CTM, thereby preventing the syn-anti photoisomerization which retards RLF. However, a need remains for hydrazone-containing photoconductors which exhibit reduced room light fatigue.

U.S. Pat. No. 5,972,549 to Levin et al. discloses photoconductors comprising a substrate, and a charge transport layer comprising binder and a charge transport compound comprising at least one of hydrazone, aromatic amine or substituted aromatic amine, and a charge generation layer comprising binder, phthalocyanine charge generating compound, and a hindered hydroxylated aromatic compound. Levin et al. teaches that the hindered hydroxylated aromatic compound reduces electrical fatigue on cycling without adversely affecting the electrical performance of the photoconuctor.

Use of DEH as the charge transport material is desirable because of its mechanical strength and low cost. DEH containing charge transport layer provides robustness against handling damage. As operating speeds have increased, crazes and cracks, crystallization of the charge transport material, and phase separation in the charge transport layer have been encountered with some CTM's, but DEH does not exhibit such defects in charge transport layers.

Although hydrazones in general show lower mobility than other known materials, such as triarylamines, in combination with a certain class of charge generation materials, as detailed below, excellent, high-speed functioning has been achieved.

### SUMMARY OF THE INVENTION

In accordance with this invention, the charge transport layer comprises a hydrazone charge transport compound, acetosol yellow, and an antioxidant which is the t-butylated reaction product of p-cresol with dicyclopentadiene. (Acetosol yellow is also known as SAVINYL YELLOW and Colour Index Solvent Yellow 138.) Photoconductors of this invention comprise a substrate, a charge generation layer and the foregoing charge transport layer. Light fatigue is largely eliminated while the physical and cost advantages of DEH are realized.

In certain embodiments having excellent high-speed photoconductor functionality, the foregoing charge transport layer is a lamination with a charge generation layer of poly(hydroxystyrene), poly(methyl-phenyl) siloxane, and Type IV phthalocyanine, the poly(hydroxystyrene) being 20 percent by weight or less of the total weight of the charge generation layer.

In certain embodiments the butylated reaction product is present in the charge transport layer in an amount of between about 0.5 to about 5 percent by weight of the total weight of the charge transport layer.

In certain embodiments the DEH is present in the charge transport layer in an amount of between about 30 percent to about 60 percent by weight of the total weight of the charge transport layer.

In certain embodiments the acetosol yellow is present in the charge transport layer in an amount of about 0.5 percent to about 5 percent by weight of the total weight of the charge transport layer.

### DESCRIPTION OF THE EMBODIMENTS

Photoconductor embodiments described below an anodized and sealed aluminum drum as a conductive substrate, a charge generation layer, and a charge transport layer. The charge generation layer typically is comprised of a photoconductive pigment, which is dispersed evenly in one or more types of resin binder before coating. The charge transport layer includes one or more charge transport molecules, and a resin binder. The foregoing and all related processing steps may be entirely standard and widely known, the novelty being in the components employed as described.

The butylated reaction product of p-cresol and dicyclopentadiene employed in the charge transport layer is believed to have the following structure:

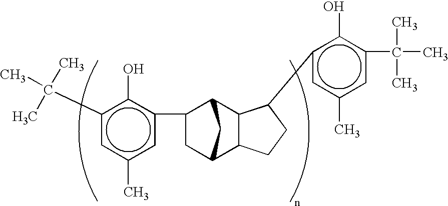

Wherein n is at least 1, preferably greater than 1, more preferably from about 1 to about 7. Generally the polymeric hindered phenol has a molecular weight in the range of from several hundred to about several thousand, such as from about 460 to about 4600, preferably from about 460 to about 2200. A suitable commercially available butylated reaction product of p-cresol and dicyclopentadiene is Wingstay® L HLS, available from Goodyear Chemicals.

### EXAMPLE 1

The charge generation layer of these embodiments is the subject of the foregoing U.S. patent application Ser. No. 09/585,045. The aluminum drum is coated with a thorough mixture by weight of 45 parts of type IV oxotitanium phthalocyanine and 55 parts of a blend of polyvinylbutyral (PVB), poly(methyl-phenyl) siloxane (PMPSiO) and polyhydroxystyrene (PHS), in the weight ratio of 50 parts polyvinylbutyral, 45 parts polysiloxane and 5 parts poly(hydroxystyrene) (50/45/5; corresponding ratios of 86/7/7, 90/3/7 and 92/1/7 have very similar performance as photoconductors). The coating is from a dispersion.

The polyvinylbutyral is BX-55Z of Sekisui Chemical Company. This has the characteristic group of reacted vinylbutyral and also has ethylene alcohol groups.

The polysiloxane is a standard polysiloxane of commercial purity, specifically Dow Corning 710 Fluid. The backbone of polysiloxanes is alternating silicon and oxygen atoms. Poly(methyl-phenyl)siloxane has one methyl group substituent and one phenyl group substituent on each silicon.

The polyhydroxystyrene is a standard polymer purchased from specifically TriQuest LP.

The charge transport layer is a thorough blend of a hydrazone charge transport compound, acetosol yellow, an antioxidant which is the butylated reaction product of p-cresol with dicyclopentadiene, and a polycarbonate binder coated from a dispersion onto the foregoing charge generation layer.

The polycarbonate binder has the following repeating general structure:

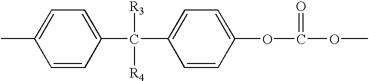

where R₃, R₄ =methyl, cyclohexyl or substituted cyclohexyl groups. When R₃ and R₄ are methyl, the material is polycarbonate A. In the following examples the polycarbonate A is MAKROLON 5208 of Bayer Inc., or, where noted, APEC 9203 also of Bayer Inc.

In the following examples, the materials were obtained from the aforementioned sources.

### Example 2

(38% DEH; 1% HLS and 1% AY)

Charge generation layer

Charge generation (CG) dispersion consists of titanyl phthalocyanine (Type IV), polyvinylbutyral, PHS and PMPSiO in a ratio of 45/30/15/5 in a mixture of 2-butanone and cyclohexanone. The CG dispersion was dip-coated on aluminum substrates and dried at 100° C. for 15 minutes to give a thickness less than 1 μm, and more preferably, 0.2-0.3 μm.

Charge transport layer

A charge transport formulation containing 38% DEH was prepared by dissolving DEH (30.7 g), acetosol yellow (0.8 g) Wingstay L HLS (0.8 g) and polycarbonate A (48.5 g), MAKROLON 5208, Bayer Inc. in a mixed solvent of tetrahydrofuran and cyclopentanone. The charge transport layer was coated on top of charge generation layer and cured at 100° C. for 1 hour to give a thickness of 24-30 μm.

### Example 3

(36% DE l; 1% HLS and 1% AY)

Charge generation layer

Same as in Example 2

Charge transport layer

A charge transport formulation containing 36% DEH was prepared by dissolving DEH (29.1 g), acetosol yellow (0.8 g), Wingstay L HLS (0.8 g) and polycarbonate A (50.1 g), in a mixed solvent of tetrahydrofuran and cyclopentanone. The charge transport layer was coated on top of the charge generation layer and cured at 100° C. for 1 hour to give a thickness of 24-30 μm.

### Example 4

(38% DEH; 1% AY, APEC, 1% HLS)

Charge generation layer

Same as Example 2

Charge transport layer

A charge transport formulation containing 38% DEH was prepared by dissolving DEH (30.7 g), acetosol yellow (0.8 g), APEC 9203 (48.5 g), Wingstay L HLS (0.8 g), in a mixed solvent of tetrahydrofuran and cyclopentanone. Charge transport layer was coated on top of charge generation layer and cured at 100° C. for 1 hour to give a thickness of 24-30 μm.

### Example 5

(38% DE B; 2% HLS and 1% AY)

Charge generation layer

Same as Example 2

Charge transport layer

A charge transport formulation containing 38% DEH was prepared by dissolving DEH (30.7 g), acetosol yellow (0.8 g), Wingstay L HLS (1.6 g) and polycarbonate A (47.7 g), in a mixed solvent of tetrahydrofuran and cyclopentanone: The charge transport layer was coated on top of the charge generation layer and cured at 100° C. for I hour to give a thickness of 24-30 μm.

### Example 6

(38% DEH; 3% HLS, 1% AY)

Charge generation layer

Same as Example 2

Charge transport layer

A charge transport formulation containing 38% DEH was prepared by dissolving DEH (30.7 g), acetosol yellow (0.8 g), Wingstay L HLS (2.4 g) and polycarbonate A (46.9 g), in a mixed solvent of tetrahydrofuran and cyclopentanone. The charge transport layer was coated on top of the charge generation layer and cured at 100° C. for 1 hour to give a thickness of 24-30 μm.

### Example 7

(38% DEH; 5% HLS and 1% AY)

Charge generation layer

Same as Example 2

Charge transport layer

A charge transport formulation containing 38% DEH was prepared by dissolving DEH (30.7 g), acetosol yellow (0.8 g), Wingstay L HLS (4.0 g) and polycarbonate A (45.3 g), in a mixed solvent of tetrahydrofuran and cyclopentanone. The charge transport layer was coated on top of the charge generation layer and cured at 100° C. for 1 hour to give a thickness of 24-30 μm.

Embodiments of this invention provide excellent functioning while permitting the use of DEH as the charge transport material.

What is claimed is:

1. A photoconductor comprising
a conductive support layer,
a charge generation layer, and
a charge transport layer, said charge transport layer comprising a binder resin, a hydrazone charge transport material, acetosol yellow and the butylated reaction product of p-cresol and dicyclopentadiene.

2. The photoconductor as in claim 1 in which said butylated reaction product is present in an amount of between about 0.5 percent to about 5 percent by weight of the total weight of said charge transport layer.

3. The photoconductor as in claim 1 in which said hydrazone is p-diethylamino benzaldehyde-(diphenylhydrazone) present in an amount of between 30 percent and 60 percent by weight of the total weight of said charge transport layer.

4. The photoconductor as in claim 2 in which said hydrazone is p-diethylamino benzaldehyde-(diphenylhydrazone) present in an amount of between 30 percent and 60 percent by weight of the total weight of said charge transport layer.

5. The photoconductor as in claim 2 in which said acetosol yellow is present in an amount between 0.5 percent and 5 percent by weight of the total weight of said charge transport layer.

6. The photoconductor as in claim 3 in which said acetosol yellow is present in an amount between 0.5 percent and 5 percent by weight of the total weight of said charge transport layer.

7. The photoconductor as in claim 4 in which said acetosol yellow is present in an amount between 0.5 percent and 5 percent by weight of the total weight of said charge transport layer.

8. The photoconductor as in claim 7 in which said charge generation layer comprises type IV oxotitanium phthalocyanine, polyvinylbutyral, poly(methyl-phenyl) siloxane and polyhydroxystyrene, said siloxane and said polyhydroxystyrene together making up 20 percent or less by weight of the total weight of said charge generation layer.

9. The photoconductor as in claim 8 in which said hydrazone is present in amount between about 36 percent and 38 percent by weight of the total weight of said charge transport layer, said acetosol yellow is in an amount of about 1 percent by weight of the total weight of said charge transport layer and said binder resin is polycarbonate.
